(19) United States
(12) Patent Application Publication
(10) Pub. No.: US 2008/0254670 A1
(43) Pub. Date: Oct. 16, 2008

(54) ELECTRICAL CONNECTORS WITH IMPROVED ELECTRICAL CONTACT PERFORMANCE

(76) Inventors: Peter J. Balsells, Newport Coast, CA (US); Robbie J. Sjostedt, Foothill Ranch, CA (US); Farshid Dilmaghanian, Rancho Santa Margarita, CA (US)

Correspondence Address: KLEIN, O'NEILL & SINGH, LLP, 43 CORPORATE PARK, SUITE 204, IRVINE, CA, 92606, US

(21) Appl. No.: 12/102,626

(22) Filed: Apr. 14, 2008

Related U.S. Application Data
(60) Provisional application No. 60/911,755, filed on Apr. 13, 2007.

(51) Int. Cl. H01R 43/00; H01R 13/627; H01R 12/00

(52) U.S. Cl. 439/352; 29/884; 439/81; 439/839; 439/863; 29/874; 29/885

(57) ABSTRACT

Electrical connectors are generally discussed herein having a housing having a bore and a groove having a canted coil spring positioned therein. A pin is inserted through the bore and is electrically connected with the canted coil spring. The canted coil spring may be coated with a noble metal and the housing and the pin may be made from non-noble metals.

### CROSS-REFERENCE TO RELATED APPLICATION

Priority is claimed to provisional application Ser. No. 60/911,755, filed on Apr. 13, 2007, entitled IMPLANTED MEDICAL ELECTRICAL CONNECTORS WITH IMPROVED ELECTRICAL CONTACT PERFORMANCE, the contents of which are hereby expressly incorporated herein by reference as if set forth in full.

The present invention is directed to medically implantable electrical connectors and more particularly to medical connectors having an improved configuration and improved reliability.

### BACKGROUND

Electrical connectors are used in a number of medical devices, such as pacemakers, defibrillators, and neuro-stimulators. Medically implantable electrical connectors are inherently different from many other electrical connectors due to the environment and critical nature of their use. Such medical connectors must not only be made from biocompatible materials, but also should provide positive and unvarying conductivity in order to ensure reliability of a functioning medical device.

Noble metals have been found to provide desirable conductivity when placed between non-noble metal materials, such as stainless steel. However, noble metals exhibit a significantly lower ultimate tensile strength and are considerably more expensive than conventional implanted materials such as stainless steel or titanium. Accordingly, there is a need to produce an electrical connector which provides the desirable conductivity of noble metals combined with the desirable spring qualities of stainless steel and is relatively inexpensive to manufacture.

### SUMMARY

Aspects of the present invention comprises an electrical connector with improved dynamic resistance. In one embodiment, the connector comprises: a housing having a bore and a groove having a canted coil spring positioned therein; and a pin inserted through the bore and in electrical communication with the canted coil spring; wherein the spring has an outer surface area made from a noble metal configured for contact with a non-noble metal surface area.

A further aspect of the present invention is a method for manufacturing an electrical connector. In one embodiment, the method comprises the steps of providing a housing having a bore and a groove for receiving a canted coil spring; coating a canted coil spring with a noble metal; inserting the canted coil spring into the groove; inserting a pin through the bore and the spring.

In yet another aspect of the present invention, a method for placing a noble metal between two non-noble metal surfaces of an electrical connector is provided. In one embodiment, the method comprises the steps of providing a housing having a groove having a surface made from a non-noble metal; placing a canted coil spring having an outer surface area made from a noble metal into the groove; and placing a pin having an outer surface area made from a non-noble metal in contact with the canted coil spring.

These and other features of the preferred electrical connector will become apparent when read in view of the drawings and detailed description as set forth herein.

### BRIEF DESCRIPTION OF THE DRAWINGS

FIG. 1 is a cross-sectional side view of a housing containing a spring according to an exemplary embodiment of the present invention.

FIG. 2 is a end view of the housing of FIG. 1.

FIG. 3 is a end view of an exemplary canted coil spring according to aspects of the present invention.

FIG. 4 is a cross-sectional side view of the canted coil spring of FIG. 3 taken along a vertical centerline of the spring coil.

FIG. 4A is a cross-sectional end view of a wire used to form the canted coil spring of FIGS. 3 and 4.

FIG. 5 is a side view of a pin according to an exemplary embodiment of the present invention.

FIG. 6 is a table showing the results of static resistance and dynamic resistance testing of canted coil springs made from various materials.

FIG. 7 is a schematic view of an exemplary contact according to the present invention.

### DETAILED DESCRIPTION

The detailed description set forth below in connection with the appended drawings is intended as a description of the presently preferred embodiments of electrical connectors coated with noble metals. The electrical connectors provided in accordance with aspects of the present invention are not intended to represent the only forms in which the present invention may be constructed or used. The description sets forth the features and the steps for constructing and using aspects of the present invention in connection with the illustrated embodiments. It is to be understood that the same or equivalent functions and structures may be accomplished by different embodiments and are also intended to be encompassed within the spirit and scope of the present invention, especially those incorporating a combination of features shown in the different embodiments included herein. As denoted elsewhere herein, like element numbers are intended to indicate like or similar elements or features. Additionally, as used herein, “contact” means a discrete electrical path from a housing through a spring to a lead, electrode, or electrical contact and “connector” means an assembly of two or more contacts.

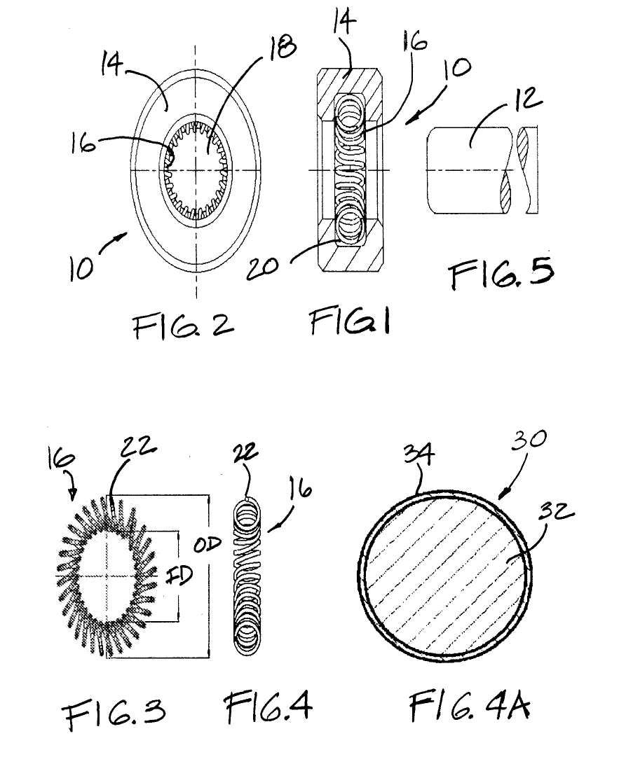

Referring now to FIGS. 1 and 2, an exemplary embodiment of a contact assembly 10 is shown. The contact assembly 10 includes a housing 14 having a centrally located bore 18 adapted to receive a lead pin 12 as described in more detail below. The housing 14 further includes a groove 20 recessed from an interior circumferential surface of the housing, the groove adapted to house a spring 16. As shown in FIG. 1, the groove 20 includes two sidewalls generally orthogonal to a longitudinal axis of the lead pin 12 and a back wall. The back wall is generally arc-shaped to match the arc of the housing 14. However, a V-groove back wall or a slanted back wall may be incorporated to change the orientation of the spring. In other embodiments, the housing is made from two or more assembled housing parts, such as an L-shape cross-section housing attached to a plate to form a housing with a groove. In one exemplary embodiment, the housing 14 is made from a non-noble metal. For example, the housing 14 may be made from high-strength nickel alloy, such as MP35N®, or stainless steel, such as 316L stainless steel.

With reference also to FIGS. 3 and 4, in one exemplary embodiment, the spring 16 is a canted coil spring and, more specifically, may be a radial or axial canted coil spring. Radial and axial canted springs are well known in the industry and are commercially available from Bal Seal Engineering of Foothill Ranch, Calif. The spring 16 includes a plurality of coils 22, each coil having a coil height and a coil width. The plurality of coils are canted along a same direction relative to a plane normal to the spring. In one exemplary embodiment, the spring is made from a non-noble metal, for example, high-strength nickel alloy, such as MP35N®, or stainless steel, such as 316L stainless steel. To couple the spring 16 to the housing 14, the spring is compressed to be insertable into the bore 18 and then allowed to expand into the groove 20 within the housing 14 such that it is constrained by the groove as shown in FIG. 2. In one exemplary embodiment, an inner diameter of an unstressed spring 16 is smaller than an inner diameter of the bore 18 such that when the spring is housed within the groove 20, a portion of each coil 22 protrudes into the bore 18. Accordingly, when a lead pin 12 having a diameter slightly smaller than an inner diameter of the bore 18 is inserted into the bore as described in more detail below, the coils 22 will make contact with the lead pin. Additionally, an outer diameter of an unstressed spring 16 may be slightly larger than the diameter of the groove 20 such that when the spring is located in the groove, the spring exerts a radial force on the back wall of the groove. In one embodiment, the lead pin 12 incorporates a tapered axial end to facilitate insertion into the bore 18. In another embodiment, the lead pin 12 incorporates a groove for seating the spring when inserted into the bore.

In one exemplary embodiment, the spring 16 is coated with a noble metal, and more specifically, a noble metal that is substantially non-oxidizing in the presence of body fluids. FIG. 4A is a cross-sectional end view of a wire 30 used to form the spring 16 of FIGS. 3 and 4. In one embodiment, the wire 30 has an inner-core 32 of a non-noble metal and an outer layer 34 having an outer surface made of a noble metal. In another embodiment, a third layer of a 2nd noble metal is incorporated. As is described in more detail below, it has been found that noble metals provide corrosion resistance and low and more consistent electrical contact resistance when they contact other non-noble metals versus non-noble metal to non-noble metal contact.

To complete the contact, a lead pin 12, as shown in FIG. 5, may be inserted through the bore 18 of the housing 14. In one exemplary embodiment, the lead pin 12 is generally cylindrical and has a diameter that is slightly smaller than an inner diameter of the bore 18 but is larger than the inner diameter of the spring so as to compress the spring when inserted into the bore. Thus, when the lead pin 12 is inserted through the bore 18, the lead pin contacts the coils 22 of the spring 16 to establish an electrical connection between the lead pin, the spring, and the housing 14. Preferably, the lead pin 12 compresses the spring to a range of about 5% to about 60% of the total radial compression of the spring and more preferably in the range of about 15% to about 45% of the total radial compression of the spring to provide sufficient spring contact force.

It has been found that when noble metals are coated onto other non-noble metal coil springs, the noble metal coating on non-noble metals produces similar results with respect to static and dynamic resistance as when a coil spring is made entirely from noble metal. As measured herein, static resistance is a measurement of the contact resistance with no motion of the lead, while dynamic resistance is a measurement of the contact resistance when the lead is in motion due to body movement.

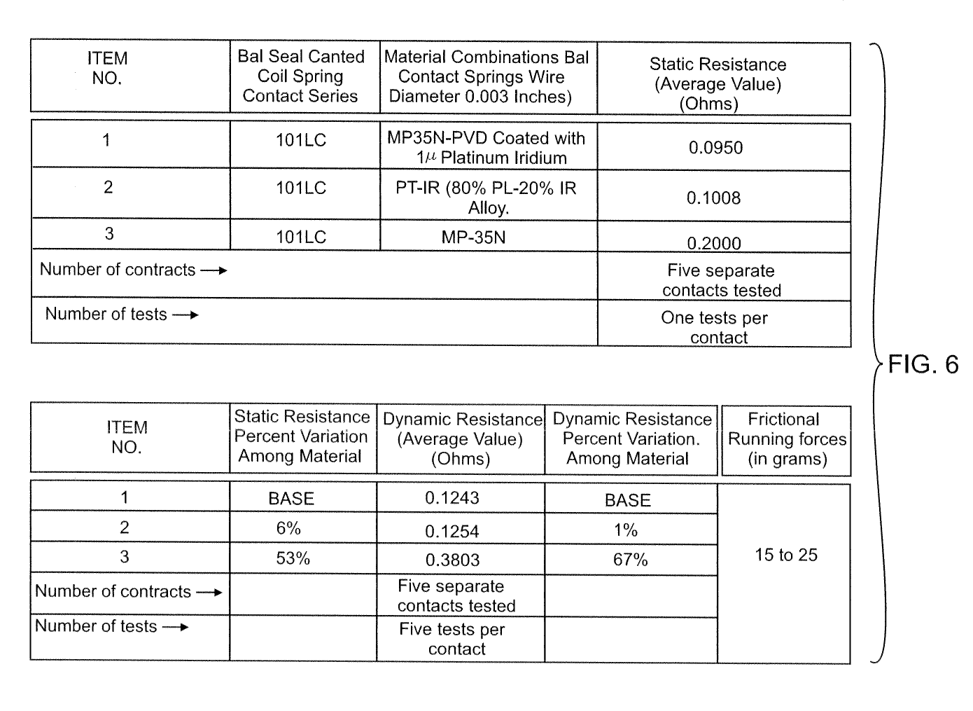

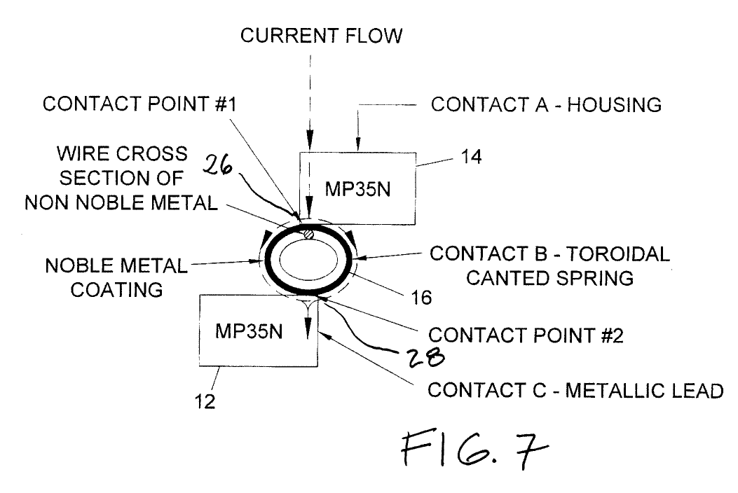

FIG. 6 shows the results of tests measuring the static and dynamic electrical contact resistance created through contacts having different configurations and properties. The static and dynamic resistance was measured using a Bal Seal canted coil spring made from (1) MP-35N® coated with 1 micron platinum, (2) entirely from platinum-iridium alloy and (3) entirely from MP-35N® nickel metal alloy. As shown in FIG. 6, using the MP-35N® coated with 1 micron platinum spring as the base value, the platinum-iridium alloy spring exhibited about 6% greater static resistance and about 1% greater dynamic resistance, while the MP-35N® spring exhibited about 53% greater static resistance and about 67% greater dynamic resistance. Accordingly, the high nickel steel MP-35N® coated with platinum-iridium spring performed significantly similarly to the spring made entirely from platinum-iridium alloy. Thus, a connector utilizing a spring made from a non-noble metal coated with a noble metal can be made much more cost effective than one made of 100% solid platinum, solid 80%-20% platinum-iridium alloy, or other solid noble metal.

By coating a non-noble metal element with a noble metal, the more desirable conductive and corrosion resistant properties of the noble metal are married with the more desirable spring properties and significantly lower cost of non-noble metals such as high-strength nickel alloys and stainless steel. Desirable spring properties include stiffness and increased spring rate. Examples of materials that may be used for coating include platinum, iridium, rhodium, rhenium, ruthenium, palladium, or alloys of two or more of such materials used in various percentages. Also, it is noteworthy that the coated spring can use pure platinum whereas the platinum only spring must have a small percentage of iridium alloyed with the platinum in order to achieve the desired spring properties. In one exemplary embodiment, the coating may be applied by a vapor disposition process, which is generally known in the coating industry. In applications where a soft coating is desired, 100% platinum may be used. In cases where a harder material is desired, for example in wear-resistant applications, a binary composition of platinum and iridium may be used. Generally, the larger percentage of iridium used, the harder is the coating. In one exemplary embodiment, the coating has a thickness of at least about 1 micron. The larger percentage of platinum used, the lower the contact resistance.

As shown schematically in FIG. 7, the contact assembly 10 includes three contact elements, which are the housing 14, the spring 16, and the lead pin 12. Together, the three contact elements have at least two contact points, which include a first contact point 26 between the housing and the spring, and a second contact point 28 between the spring and the lead pin. Positioning a contact element including a noble metal or a noble metal alloy between two non-noble metals have been found to eliminate or reduce oxidation or other adverse corrosion at the first and second contact points 26, 28 by a materially significant amount. Accordingly, because of the substantial lack of measurable oxidation, there is a substantial lack of resistivity change through these points. As noted above, it has been found that the lack of resistivity change between the contact points 26, 28 is substantially equal whether the noble metal contact element (i.e., the spring 16) is made entirely from a noble metal or whether the noble metal contact element is merely coated with a noble metal.

As can be appreciated, aspects of the present invention includes a method for maintaining static and/or dynamic resistance in an electrical connector to within 20% or less, preferably to 10% or less, and still more preferably to within 6% or less, using a spring having a wire made from at least one non-noble metal core and at least one outer layer of a noble metal compared to a spring having a wire made entirely from a noble metal. A still further aspect of the present invention is a method for maintaining static and/or dynamic resistance in an electrical connector to perform 30% or better, preferably 40% or better, and still more preferably 50% or better, using a spring having a wire made from at least one non-noble metal core and at least one outer layer of a noble metal compared to a spring having a wire made entirely from a non-noble metal.

The spring 16 described elsewhere herein may be used with the connector assemblies shown and described in U.S. patent application Ser. No. 60/911,161, filed Apr. 11, 2007, entitled INTEGRATED HEADER CONNECTOR SYSTEM, Ser. No. 60/910,765, filed Apr. 9, 2007, entitled CONNECTOR ASSEMBLY FOR USE WITH MEDICAL DEVICES, Ser. No. 12/062,895, filed Apr. 4, 2007, entitled CONNECTOR ASSEMBLY FOR USE WITH MEDICAL DEVICES, and to Ser. No. 61/044,408, entitled ENCAPSULATED CONNECTOR STACK. The contents of the foregoing provisional/ordinary applications are expressly incorporated herein by reference as if set forth in full.

Although limited exemplary embodiments and methods for making and using electrical connectors provided in accordance with aspects of the present invention have been specifically described and illustrated, many modifications and variations will be apparent to those skilled in the art. For example, various materials may be used and the coating may be applied by various coating methods and the electrical connector can be used in non-implant applications, such as for a car battery terminal. Additionally, various types of springs and housings may be used and the springs and housings may have a wide variety of configurations. For example, the pin can be part of a battery terminal and the housing attached to a lead conductor for carrying electrical current to another device. Accordingly, it is to be understood that the electrical connectors constructed according to principle of this invention may be embodied other than as specifically described herein. The invention is also defined in the following claims.

What is claimed is:

1. An electrical connector with improved dynamic resistance comprising:
a housing having a bore and a groove having a canted coil spring positioned therein; and
a pin inserted through the bore and in electrical communication with the canted coil spring;
wherein the spring has an outer surface area made from a noble metal configured for contact with a non-noble metal surface area.

2. The electrical connector of claim 1, wherein the non-noble metal surface area is on the pin or the groove of the housing.

3. The electrical connector of claim 1, wherein the spring has an inner core made from a non-noble metal.

4. The electrical connector of claim 1, wherein the non-noble metal is selected from at least one of platinum, iridium, rhodium, rhenium, ruthenium, palladium, and combinations thereof.

5. The electrical connector of claim 3, wherein the inner core is made from a nickel alloy or a stainless steel material.

6. The electrical connector of claim 1, wherein the spring is a radial canted coil spring.

7. A method for manufacturing an electrical connector comprising:
providing a housing having a bore and a groove for receiving a canted coil spring;
coating a canted coil spring with a noble metal;
inserting the canted coil spring into the groove;
inserting a pin through the bore and the spring.

8. The method of claim 7, wherein the noble metal is coated over a non-noble metal material.

9. The method of claim 7, wherein the housing is made from a non-noble metal material.

10. The method of claim 7, wherein the housing is made from at least two different housing sections.

11. The method of claim 7, wherein the pin comprises a groove.

12. The method of claim 8, wherein the noble metal is selected from at least one of platinum, iridium, rhodium, rhenium, ruthenium, palladium, and combinations thereof and the non-noble metal is selected from a nickel alloy metal or a stainless steel material.

13. A method for placing a noble metal between two non-noble metal surfaces of an electrical connector comprising:
providing a housing having a groove having a surface made from a non-noble metal;
placing a canted coil spring having an outer surface area made from a noble metal into the groove; and
placing a pin having an outer surface area made from a non-noble metal in contact with the canted coil spring.

14. The method of claim 13, wherein the noble metal is selected from at least one of platinum, iridium, rhodium, rhenium, ruthenium, palladium, and combinations thereof.

15. The method of claim 13, wherein the noble metal is coated over a non-noble metal core.

16. The method of claim 13, wherein the housing comprises two side walls, at least one of which made from a separately formed housing section.

17. The method of claim 13, wherein the pin is part of a batter terminal.

18. The method of claim 13, wherein the housing comprises an exterior surface in contact with a lead conductor.

19. The method of claim 13, wherein the groove comprises a generally V-shape wall surface.
